(19) United States
(12) Patent Application Publication
(10) Pub. No.: US 2023/0283134 A1
(43) Pub. Date: Sep. 7, 2023

(54) STATOR AND MOTOR

(71) Applicant: Komatsu Ltd., Tokyo (JP)

(72) Inventors: Hiroki Hijikata, Tokyo (JP); Natsuki Watanabe, Tokyo (JP)

(73) Assignee: Komatsu Ltd., Tokyo (JP)

(21) Appl. No.: 18/018,943

(22) PCT Filed: Sep. 22, 2021
(86) PCT No.: PCT/JP2021/034725

§ 371 Date: Jan. 31, 2023

(30) Foreign Application Priority Data
Sep. 28, 2020 (JP) 2020-162172

(51) Int. Cl. H02K 3/28

(52) U.S. Cl. CPC H02K 3/28

(57) ABSTRACT

A stator includes: a stator core having teeth and slots; and coils including outer coils arranged at a first distance from a center of the stator core and inner coils arranged at a second distance shorter than the first distance, wherein the slots include first slots that the outer coils are arranged and second slots that the inner coils are arranged, a depth of the first slots is deeper than that of the second slots, each of coil sets is formed of each of the inner coil and the outer coil arranged to overlap with a part of the inner coil, phases of the inner and outer coils are different in each of the coil sets, the coil sets include first, second, and third coil sets, and a combination of the phases of the inner and outer coils varies among the first, second and third coil sets.

### FIELD

The present disclosure relates to a stator and a motor.

### BACKGROUND

A stator of a motor includes a stator core and a coil mounted on the stator core. The stator core has a slot in which a coil is arranged. Patent Literature 1 discloses a stator core having a slot into which an outer phase coil is inserted, a slot into which a middle phase coil is inserted, and a slot into which an inner phase coil is inserted.

### CITATION LIST

### Patent Literature

Patent Literature 1: JP 2017-169419 A

### SUMMARY

### Technical Problem

In Patent Literature 1, a difference is provided in depths of three types of slots in order to reduce a loss generated in a stator core. An outer phase coil, a middle phase coil, and an inner phase coil are arranged in such a manner as to overlap with each other in a radial direction in a state in which positions in a circumferential direction are shifted. When the three coils are arranged in such a manner as to overlap with each other in the radial direction, it is difficult to control a size of a stator in the radial direction. When it becomes difficult to control the size of the stator, it becomes difficult to control an increase in a size of a motor.

An object of the present disclosure is to control an increase in a size of a motor and to reduce a loss generated in a stator core.

### Solution to Problem

According to an aspect of the present invention, a stator comprises: a stator core having a plurality of teeth arranged in a circumferential direction and slots each of which is provided between the teeth adjacent to each other; and coils mounted on the plurality of teeth, wherein the coils include outer coils arranged at a first distance from a center of the stator core and inner coils arranged at a second distance from the center of the stator core, the second distance being shorter than the first distance, the slots include first slots in which the outer coils are arranged and second slots in which the inner coils are arranged, a depth of the first slots is deeper than a depth of the second slots, each of coil sets is formed of each of the inner coils and the outer coil arranged in such a manner as to overlap with a part of the inner coil, a phase of the inner coil and a phase of the outer coil are different in each of the coil sets, the coil sets include a first coil set, a second coil set, and a third coil set, and a combination of the phase of the inner coil and the phase of the outer coil varies among the first coil set, the second coil set, and the third coil set. Advantageous Effects of Invention

According to the present disclosure, an increase in a size of a motor is controlled, and a loss generated in a stator core is reduced.

### BRIEF DESCRIPTION OF DRAWINGS

FIG. 1 is a view schematically illustrating a motor according to a first embodiment.

FIG. 2 is a perspective view illustrating a stator according to the first embodiment.

FIG. 3 is a perspective view illustrating a stator core according to the first embodiment.

FIG. 4 is a perspective view illustrating a stator according to a second embodiment.

FIG. 5 is a perspective view illustrating a stator core according to the second embodiment.

FIG. 6 is a perspective view illustrating a stator according to a third embodiment.

FIG. 7 is a plan view illustrating a stator core according to the third embodiment.

FIG. 8 is a perspective view illustrating a first coil set according to the third embodiment.

FIG. 9 is a view illustrating a third coil set arranged in a slot according to the third embodiment. Description of Embodiments

In the following, embodiments according to the present disclosure will be described with reference to the drawings. However, the present disclosure is not limited to the embodiments. Components of the embodiments described in the following can be arbitrarily combined. In addition, there is a case where a part of the components is not used.

### FIRST EMBODIMENT

The first embodiment will be described.

### Motor

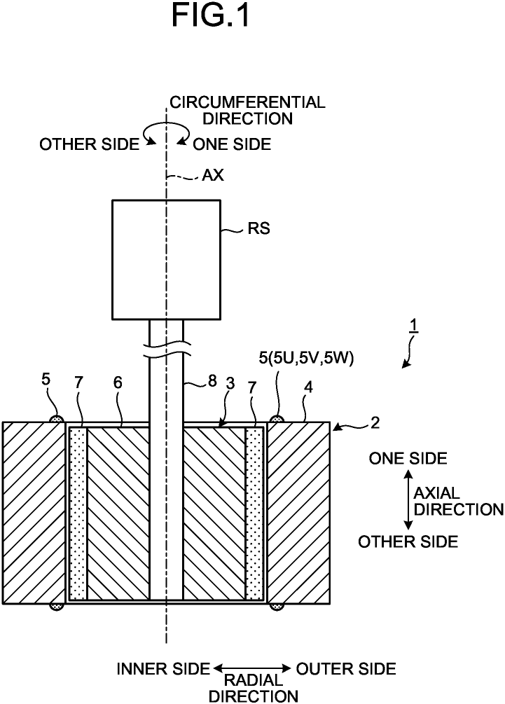

FIG. 1 is a view schematically illustrating a motor 1 according to the embodiment. In the embodiment, the motor 1 is a switched reluctance motor. As illustrated in FIG. 1, the motor 1 includes a stator 2 and a rotor 3.

The motor 1 is an inner rotor type. The stator 2 is arranged around the rotor 3. The rotor 3 faces the stator 2. The rotor 3 rotates about a rotation axis AX.

In the embodiment, a direction parallel to the rotation axis AX is appropriately referred to as an axial direction, a direction around the rotation axis AX is appropriately referred to as a circumferential direction, and a radiation direction of the rotation axis AX is appropriately referred to as a radial direction.

A direction or a position separated from a center of the motor 1 in a prescribed direction in the axial direction is appropriately referred to as one side in the axial direction, and an opposite side in the axial direction of the one side in the axial direction is appropriately referred to as the other side in the axial direction. A prescribed direction in the circumferential direction is appropriately referred to as one side in the circumferential direction, and an opposite side in the circumferential direction of the one side in the circumferential direction is appropriately referred to as the other side in the circumferential direction. A direction or a position separated from the rotation axis AX in the radial direction is appropriately referred to as an outer side in the radial direction, and an opposite side in the radial direction of the outer side in the radial direction is appropriately referred to as an inner side in the radial direction.

The stator 2 includes a stator core 4 and a coil 5. The stator core 4 is arranged around the rotation axis AX. The coil 5 is mounted on the stator core 4.

The rotor 3 is arranged on the inner side of the stator core 4. The rotor 3 includes a rotor holder 6, a rotor core 7, and a rotor shaft 8. The rotor holder 6 is a non-magnetic body. The rotor core 7 is a magnetic body. The rotor core 7 is held by the rotor holder 6. The rotor core 7 functions as a pole of the rotor 3.

The rotor 3 is connected to an object RS via the rotor shaft 8. Examples of the object RS include an engine mounted on a hybrid excavator that is a kind of construction machine. The motor 1 functions as a generator driven by the engine.

### Stator

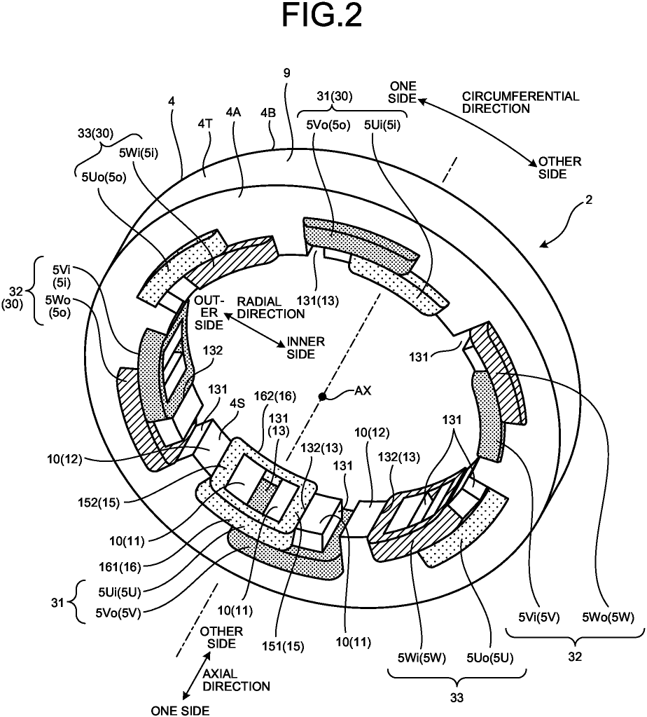

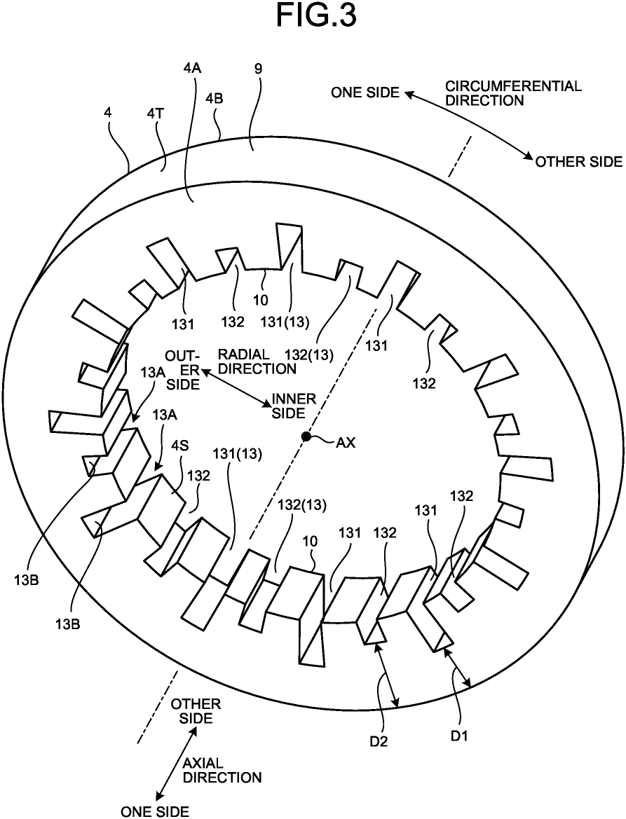

FIG. 2 is a perspective view illustrating the stator 2 according to the embodiment. FIG. 3 is a perspective view illustrating the stator core 4 according to the embodiment.

The stator core 4 includes a plurality of stacked steel plates. The stator core 4 includes a yoke 9 and teeth 10. The yoke 9 is arranged around the rotation axis AX. The yoke 9 has a tubular shape centered on the rotation axis AX. The yoke 9 has a circular outer shape in a plane orthogonal to the rotation axis AX. The teeth 10 protrude to the inner side in the radial direction from an inner surface of the yoke 9. The plurality of teeth 10 is arranged at intervals in the circumferential direction. In the embodiment, 24 teeth 10 are provided.

Surfaces of the stator core 4 include an end surface 4A, an end surface 4B, an inner surface 4S, and an outer surface 4T.

The end surface 4A faces the one side in the axial direction. The end surface 4A includes an end surface of the yoke 9 which surface faces the one side in the axial direction, and end surfaces of the teeth 10 which surfaces face the one side in the axial direction. The end surface of the yoke 9 and the end surfaces of the teeth 10 are flush with each other. The end surface 4A and an axis parallel to the rotation axis AX are orthogonal to each other.

The end surface 4B faces the other side in the axial direction. The end surface 4B includes an end surface of the yoke 9 which surface faces the other side in the axial direction, and end surfaces of the teeth 10 which surfaces face the other side in the axial direction. The end surface of the yoke 9 and the end surfaces of the teeth 10 are flush with each other. The end surface 4B and an axis parallel to the rotation axis AX are orthogonal to each other.

The inner surface 4S faces the inner side in the radial direction. The inner surface 4S includes inner surfaces of the teeth 10. The inner surface 4S faces the rotor 3. The inner surface 4S is parallel to the rotation axis AX.

The outer surface 4T faces the outer side in the radial direction. The outer surface 4T includes an outer surface of the yoke 9. The outer surface 4T is parallel to the rotation axis AX. In a plane orthogonal to the rotation axis AX, the outer surface 4T has a circular shape centered on the rotation axis AX.

The coil 5 is mounted on the stator core 4 via an insulator (not illustrated). A plurality of the coils 5 is provided. The plurality of coils 5 is formed separately. In the embodiment, the coils 5 are so-called cassette coils. Each of the coils 5 is formed by winding of one conductor in a spiral shape. Examples of the spirally wound conductor include a square wire, a rectangular wire, and a round wire. Note that each of the coils 5 may be formed by connection of a plurality of conductors in a spiral shape. Examples of the conductors connected in the spiral shape include a plate-shaped segment conductor.

The coils 5 are mounted on the teeth 10. A slot 13 is provided between the adjacent teeth 10. A plurality of the slots 13 is provided in the circumferential direction. In the embodiment, 24 slots 13 are provided. The slots 13 extend in the axial direction. Ends on the one side in the axial direction of the slots 13 are connected to the end surface 4A. Ends on the other side in the axial direction of the slots 13 are connected to the end surface 4B. A part of the coils 5 is arranged in the slots 13. A part of the coils 5 protrudes in the axial direction from the stator core 4.

The coils 5 are mounted on some of the teeth 10 among the plurality of teeth 10. The teeth 10 include mounted teeth 11 on which the coils 5 are mounted and non-mounted teeth 12 on which the coils 5 are not mounted.

In the embodiment, a winding method of the coils 5 is distributed winding in which one coil 5 is mounted on the plurality of teeth 10. In the embodiment, one coil 5 is mounted on two teeth 10 (mounted teeth 11). That is, the coils 5 are mounted on the stator core 4 at a pitch of two slots. Furthermore, the winding method of the coils 5 is a single layer winding in which one coil 5 is arranged in one slot 13.

Each of the coils 5 includes a coil main body 15 and a coil end portion 16. The coil main body 15 is arranged in the slot 13. The coil end portion 16 protrudes in the axial direction from the stator core 4.

A pair of the coil main bodies 15 is provided in the coil 5. The coil main bodies 15 include a first coil main body 151 and a second coil main body 152. In a case where the first coil main body 151 is arranged in a predetermined slot 13, the second coil main body 152 is arranged in a slot 13 two slots away from the slot 13 in which the first coil main body 151 is arranged.

A pair of the coil end portions 16 is provided in each of the coils 5. The coil end portions 16 include a first coil end portion 161 and a second coil end portion 162. The first coil end portion 161 protrudes from the end surface 4A of the stator core 4 to the one side in the axial direction. The second coil end portion 162 protrudes from the end surface 4B of the stator core 4 to the other side in the axial direction.

The coils 5 include outer coils 5o arranged at a first distance from the center of the stator core 4, and inner coils 5i arranged at a second distance from the center of the stator core 4, the second distance being shorter than the first distance. The center of the stator core 4 coincides with a rotation AX.

The first distance means a distance between the rotation axis AX in the radial direction and an end on the inner side in the radial direction of each of the outer coils 5o. The second distance means a distance between the rotation axis AX in the radial direction and an end on the inner side in the radial direction of each of the inner coils 5i.

The ends on the inner side in the radial direction of the inner coils 5i are arranged on the inner side in the radial direction of the ends on the inner side in the radial direction of the outer coils 5o. In the embodiment, all of the inner coils 5i are arranged on the inner side in the radial direction of the outer coils 5o.

The motor 1 is a three-phase motor. The coil 5 includes a U-phase coil 5U, a V-phase coil 5V, and a W-phase coil 5W. In the embodiment, 12 coils 5 are provided. Four U-phase coils 5U are provided. Four V-phase coils 5V are provided. Four W-phase coils 5W are provided.

The outer coils 5o include outer U-phase coils 5Uo, outer V-phase coils 5Vo, and outer W-phase coils 5Wo. The inner coils 5i include inner U-phase coils 5Ui, inner V-phase coils 5Vi, and inner W-phase coils 5Wi.

The four U-phase coils 5U are arranged at different positions in the circumferential direction. The four U-phase coils 5U are arranged at intervals of about 90° around the rotation axis AX. One U-phase coil 5U is mounted on the two mounted teeth 11. The outer U-phase coils 5Uo are arranged at a first distance from the rotation axis AX. The inner U-phase coils 5Ui are arranged at a second distance from the rotation axis AX. Two outer U-phase coils 5Uo are provided. Two inner U-phase coils 5Ui are provided. The outer U-phase coils 5Uo and the inner U-phase coils 5Ui are alternately arranged in the circumferential direction. The two outer U-phase coils 5Uo are arranged in such a manner as to face each other in the radial direction. The two inner U-phase coils 5Ui are arranged in such a manner as to face each other in the radial direction.

The four V-phase coils 5V are arranged at different positions in the circumferential direction. The four V-phase coils 5V are arranged at intervals of about 90° around the rotation axis AX. One V-phase coil 5V is mounted on the two mounted teeth 11. The outer V-phase coils 5Vo are arranged at the first distance from the rotation axis AX. The inner V-phase coils 5Vi are arranged at the second distance from the rotation axis AX. Two outer V-phase coils 5Vo are provided. Two inner V-phase coils 5Vi are provided. The outer V-phase coils 5Vo and the inner V-phase coils 5Vi are alternately arranged in the circumferential direction. The two outer V-phase coils 5Vo are arranged in such a manner as to face each other in the radial direction. The two inner V-phase coils 5Vi are arranged in such a manner as to face each other in the radial direction.

The four W-phase coils 5W are arranged at different positions in the circumferential direction. The four W-phase coils 5W are arranged at intervals of about 90° around the rotation axis AX. One W-phase coil 5W is mounted on the two mounted teeth 11. The outer W-phase coils 5Wo are arranged at the first distance from the rotation axis AX. The inner W-phase coils 5Wi are arranged at the second distance from the rotation axis AX. Two outer W-phase coils 5Wo are provided. Two inner W-phase coils 5Wi are provided. The outer W-phase coils 5Wo and the inner W-phase coils 5Wi are alternately arranged in the circumferential direction. The two outer W-phase coils 5Wo are arranged in such a manner as to face each other in the radial direction. The two inner W-phase coils 5Wi are arranged in such a manner as to face each other in the radial direction.

The slots 13 are formed in such a manner as to be recessed to the outer side in the radial direction from the inner surface 4S. The slots 13 have openings 13A facing the rotor 3, and outer end surfaces 13B. The openings 13A are formed in the inner surface 4S. The outer end surfaces 13B face the inner side in the radial direction. The outer end surfaces 13B are connected to each of the end surface 4A and the end surface 4B. The outer end surfaces 13B form a boundary with the yoke 9. On the inner surfaces of the slots 13, the outer end surfaces 13B are arranged on the outermost side in the radial direction.

In the embodiment, the slots 13 include first slots 131 in which the outer coils 5o are arranged, and second slots 132 in which the inner coils 5i are arranged.

The plurality of first slots 131 is provided. The plurality of first slots 131 is provided at different positions in the circumferential direction. The plurality of second slots 132 is provided. The plurality of second slots 132 is provided at different positions in the circumferential direction.

In the embodiment, one first slot 131 and one second slot 132 are alternately arranged in the circumferential direction.

The coil main bodies 15 of the outer U-phase coils 5Uo, the coil main bodies 15 of the outer V-phase coils 5Vo, and the coil main bodies 15 of the outer W-phase coils 5Wo are respectively arranged in the first slots 131. In a case where the first coil main body 151 of one of the outer U-phase coils 5Uo is arranged in a predetermined first slot 131, the second coil main body 152 of the outer U-phase coil 5Uo is arranged in a first slot 131 next to the first slot 131 in which the first coil main body 151 is arranged. The same applies to the outer V-phase coils 5Vo and the outer W-phase coils 5Wo.

The coil main bodies 15 of the inner U-phase coils 5Ui, the coil main bodies 15 of the inner V-phase coils 5Vi, and the coil main bodies 15 of the inner W-phase coils 5Wi are respectively arranged in the second slots 132. In a case where the first coil main body 151 of one of the inner U-phase coils 5Ui is arranged in a predetermined second slot 132, the second coil main body 152 of the inner U-phase coil 5Ui is arranged in the second slot 132 adjacent to the second slot 132 in which the first coil main body 151 is arranged. The same applies to the inner V-phase coils 5Vi and the inner W-phase coils 5Wi.

A depth of the first slots 131 is deeper than a depth of the second slots 132. The depth of the slots 13 means a size of the slots 13 in the radial direction. That is, the depth of the slots 13 means a distance between the inner surface 4S (opening 13A) and the outer end surfaces 13B in the radial direction.

As illustrated in FIG. 3, a yoke thickness D1 in the first slot 131 is smaller than a yoke thickness D2 in the second slot 132. The yoke thickness in the slot 13 refers to a distance between the outer end surface 13B and the outer surface 4T in the radial direction.

In the embodiment, each of the outer coils 5o and each of the inner coils 5i are arranged in such a manner that parts thereof overlap with each other in the radial direction. In the circumferential direction, a position of the inner coils 5i and a position of the outer coils 5o are shifted for a size of one tooth 10. The inner coil 5i, and the outer coil 5o arranged in such a manner as to overlap with a part of the inner coil 5i in the radial direction form a coil set 30.

In one coil set 30, a phase of the inner coil 5i and a phase of the outer coil 5o are different. The coil set 30 is formed of a set of the inner coil 5i of a first phase and the outer coil 5o of a second phase different from the first phase.

The coil sets 30 include first coil sets 31, second coil sets 32, and third coil sets 33.

Each of the first coil sets 31 is formed of the inner U-phase coil 5Ui, and the outer V-phase coil 5Vo arranged in such a manner as to overlap with a part of the inner U-phase coil 5Ui. The inner U-phase coil 5Ui is arranged on the inner side in the radial direction of the outer V-phase coil 5Vo. In the circumferential direction, a position of the inner U-phase coil 5Ui and a position of the outer V-phase coil 5Vo are shifted for the size of the one tooth 10.

Each of the second coil sets 32 is formed of the inner V-phase coil 5Vi, and the outer W-phase coil 5Wo arranged in such a manner as to overlap with a part of the inner V-phase coil 5Vi. The inner V-phase coil 5Vi is arranged on the inner side in the radial direction of the outer W-phase coil 5Wo. In the circumferential direction, a position of the inner V-phase coil 5Vi and a position of the outer W-phase coil 5Wo are shifted for the size of the one tooth 10.

Each of the third coil sets 33 is formed of the inner W-phase coil 5Wi, and the outer U-phase coil 5Uo arranged in such a manner as to overlap with a part of the inner W-phase coil 5Wi. The inner W-phase coil 5Wi is arranged on the inner side in the radial direction of the outer U-phase coil 5Uo. In the circumferential direction, a position of the inner W-phase coil 5Wi and a position of the outer U-phase coil 5Uo are shifted for the size of the one tooth 10.

As described above, a combination of the phase of the inner coil 5i and the phase of the outer coil 5o varies among the first coil sets 31, the second coil sets 32, and the third coil sets 33. The first coil sets 31 are a combination of the U phase and the V phase, the second coil sets 32 are a combination of the V phase and the W phase, and the third coil sets 33 are a combination of the W phase and the U phase.

The coil sets 30 are mounted on the mounted teeth 11. The coil sets 30 are not mounted on the non-mounted teeth 12. In the embodiment, the first coil sets 31, the second coil sets 32, and the third coil sets 33 are arranged in such a manner as not to overlap with each other. That is, a position of each of the first coil sets 31, a position of each of the second coil sets 32, and a position of each of the third coil sets 33 are different in the circumferential direction. The non-mounted tooth 12 is arranged between each of the first coil sets 31 and each of the second coil sets 32. The non-mounted tooth 12 is arranged between each of the second coil sets 32 and each of the third coil sets 33. The non-mounted tooth 12 is arranged between each of the third coil sets 33 and each of the first coil sets 31.

### Effect

As described above, according to the embodiment, in the stator 2 of the distributed winding in which each of the coils 5 is mounted on the plurality of teeth 10, a depth of the first slots 131 in which the outer coils 5o are arranged is deeper than a depth of the second slots 132 in which the inner coils 5i are arranged. The yoke thickness D2 in the second slots 132 is larger than the yoke thickness D1 in the first slots 131. A magnetic flux passes between the outer end surfaces 13B and the outer surface 4T. When the yoke thickness is small, magnetic flux density between the outer end surfaces 13B and the outer surface 4T increases. As a result, a loss generated in the stator core 4 increases. In the embodiment, since the yoke thickness D2 in the second slots 132 is large, an increase in the magnetic flux density between the outer end surfaces 13B of the second slots 132 and the outer surface 4T is controlled. Thus, a loss generated in the stator core 4 is reduced.

In the embodiment, each of the coil sets 30 is formed of the inner coil 5i and the outer coil 5o of different phases. The number of the coils 5 arranged in an overlapped manner in the radial direction is two. As a result, the size of the stator 2 in the radial direction is controlled. Thus, an increase in a size of the motor 1 is controlled.

In the embodiment, the motor 1 is a three-phase motor. The first coil sets 31, the second coil sets 32, and the third coil sets 33 are formed as the coil sets 30. A combination of the phase of the inner coil 5i and the phase of the outer coil 5o varies among the first coil sets 31, the second coil sets 32, and the third coil sets 33. As a result, a rotating magnetic field is appropriately generated in the stator 2.

### SECOND EMBODIMENT

The second embodiment will be described. In the following description, the same sign is assigned to a component same as or equivalent to that of the above-described embodiment, and a description thereof is simplified or omitted.

### Stator

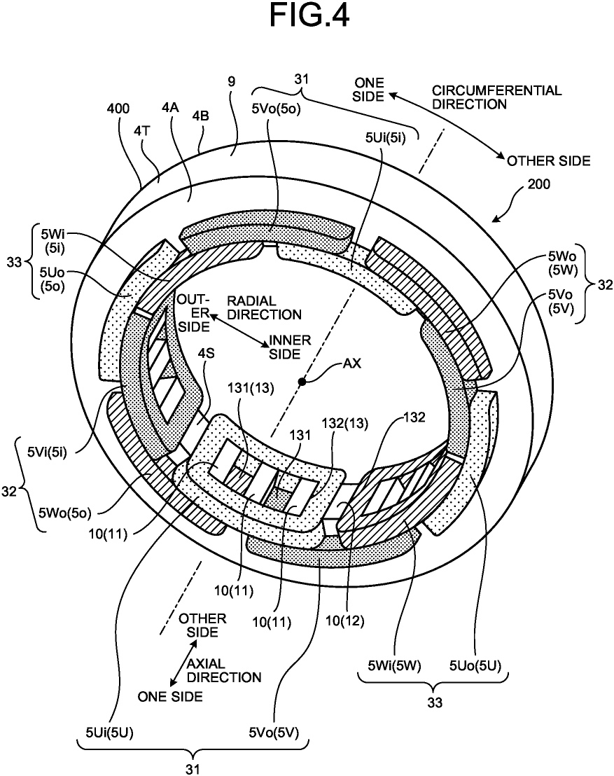

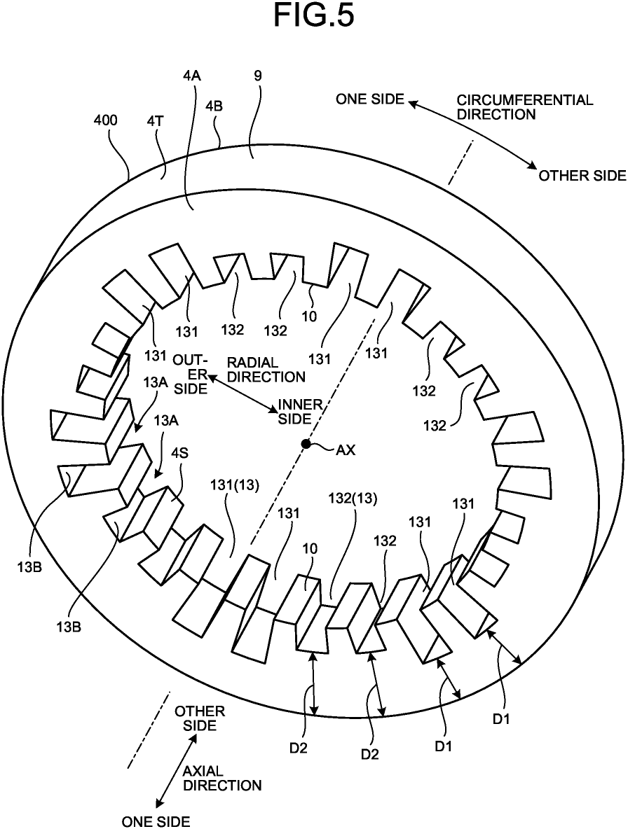

FIG. 4 is a perspective view illustrating a stator 200 according to the embodiment. FIG. 5 is a perspective view illustrating a stator core 400 according to the embodiment.

A winding method of a coil 5 is distributed winding. In the embodiment, one coil 5 is mounted on three teeth 10 (mounted teeth 11). That is, the coils 5 are mounted on the stator core 400 at a pitch of three slots.

In the embodiment, two first slots 131 are provided in such a manner as to be adjacent to each other in the circumferential direction, and the two second slots 132 are provided in such a manner as to be adjacent to each other in the circumferential direction. Two first slots 131 and two second slots 132 are alternately provided in the circumferential direction.

Outer U-phase coils 5Uo, outer V-phase coils 5Vo, and outer W-phase coils 5Wo are respectively arranged in the first slots 131. Inner U-phase coils 5Ui, inner V-phase coils 5Vi, and inner W-phase coils 5Wi are respectively arranged in the second slots 132. A depth of the first slots 131 is deeper than a depth of the second slots 132.

As illustrated in FIG. 5, a yoke thickness D1 in the first slots 131 is smaller than a yoke thickness D2 in the second slots 132.

Each of first coil sets 31 is formed of an inner U-phase coil 5Ui, and an outer V-phase coil 5Vo arranged in such a manner as to overlap with a part of the inner U-phase coil 5Ui.

Each of second coil sets 32 is formed of an inner V-phase coil 5Vi, and an outer W-phase coil 5Wo arranged in such a manner as to overlap with a part of the inner V-phase coil 5Vi.

Each of third coil sets 33 is formed of an inner W-phase coil 5Wi, and an outer U-phase coil 5Uo arranged in such a manner as to overlap with a part of the inner W-phase coil 5Wi.

In the embodiment, the inner U-phase coil 5Ui of the first coil set 31 and a part of the outer W-phase coil 5Wo of the second coil set 32 are arranged in such a manner as to overlap with each other in a radial direction. The inner U-phase coil 5Ui is arranged on an inner side in the radial direction of the outer V-phase coil 5Vo and the outer W-phase coil 5Wo. In a circumferential direction, a position of the inner U-phase coil 5Ui and a position of the outer V-phase coil 5Vo are shifted for a size of two teeth 10. In the circumferential direction, the position of the inner U-phase coil 5Ui and a position of the outer W-phase coil 5Wo are shifted for the size of the two teeth 10.

The inner V-phase coil 5Vi of the second coil set 32 and a part of the outer U-phase coil 5Uo of the third coil set 33 are arranged in such a manner as to overlap with each other in the radial direction. The inner V-phase coil 5Vi is arranged on the inner side in the radial direction of the outer W-phase coil 5Wo and the outer U-phase coil 5Uo. In the circumferential direction, a position of the inner V-phase coil 5Vi and the position of the outer W-phase coil 5Wo are shifted for the size of the two teeth 10. In the circumferential direction, the position of the inner V-phase coil 5Vi and a position of the outer U-phase coil 5Uo are shifted for the size of the two teeth 10.

The inner W-phase coil 5Wi of the third coil set 33 and a part of the outer V-phase coil 5Vo of the first coil set 31 are arranged in such a manner as to overlap with each other in the radial direction. The inner W-phase coil 5Wi is arranged on the inner side in the radial direction of the outer U-phase coil 5Uo and the outer V-phase coil 5Vo. In the circumferential direction, a position of the inner W-phase coil 5Wi and the position of the outer U-phase coil 5Uo are shifted for the size of the two teeth 10. In the circumferential direction, the position of the inner W-phase coil 5Wi and the position of the outer V-phase coil 5Vo are shifted for the size of the two teeth 10.

### Effect

As described above, in the embodiment, a depth of the first slots 131 in which the outer coils 5o are arranged is deeper than a depth of the second slots 132 in which the inner coils 5i are arranged. Thus, the yoke thickness D2 in the second slots 132 is larger than the yoke thickness D1 in the first slots 131. Since the yoke thickness D2 in the second slots 132 is large, an increase in magnetic flux density between outer end surfaces 13B of the second slots 132 and an outer surface 4T is controlled. Thus, a loss generated in the stator core 400 is reduced.

The number of the coils 5 arranged in an overlapped manner in the radial direction is two. As a result, a size of the stator 200 in the radial direction is controlled. Thus, an increase in a size of the motor 1 is controlled.

A combination of the phase of the inner coil 5i and the phase of the outer coil 5o varies among the first coil sets 31, the second coil sets 32, and the third coil sets 33. As a result, a rotating magnetic field is appropriately generated in the stator 2.

### THIRD EMBODIMENT

The third embodiment will be described. In the following description, the same sign is assigned to a component same as or equivalent to that of the above-described embodiment, and a description thereof is simplified or omitted.

### Stator

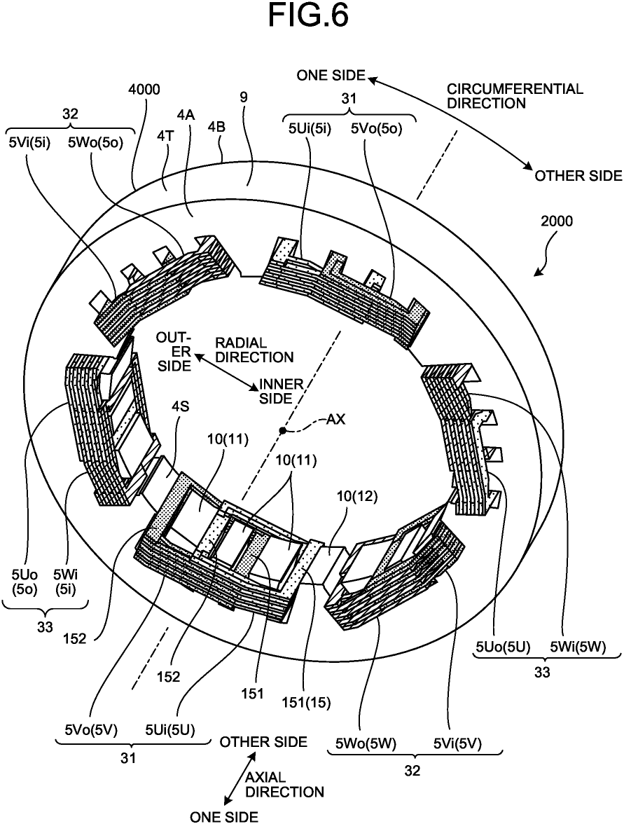

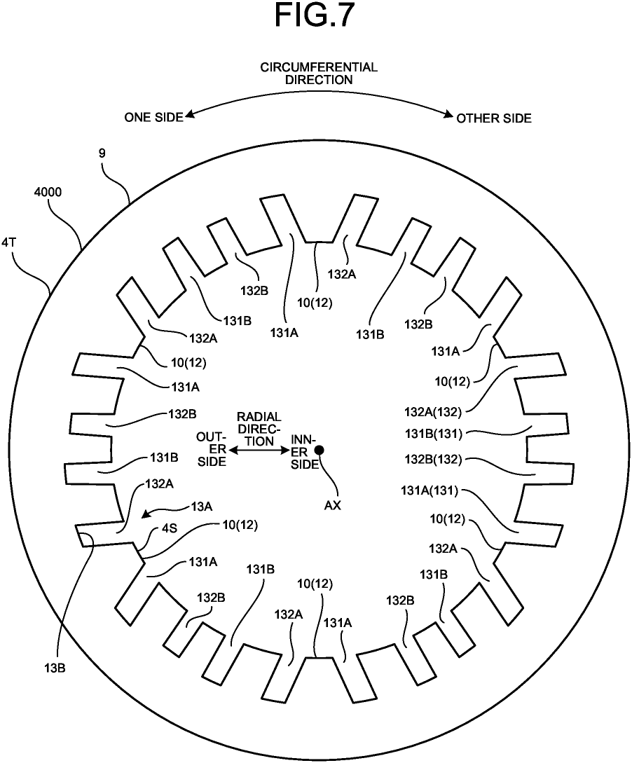

FIG. 6 is a perspective view illustrating a stator 2000 according to the embodiment. FIG. 7 is a plan view illustrating a stator core 4000 according to the embodiment.

A winding method of a coil 5 is distributed winding. In the embodiment, one coil 5 is mounted on two teeth 10 (mounted teeth 11). That is, the coils 5 are mounted on the stator core 4000 at a pitch of two slots.

Each of first coil sets 31 is formed of an inner U-phase coil 5Ui, and an outer V-phase coil 5Vo arranged in such a manner as to overlap with a part of the inner U-phase coil 5Ui. An end on an inner side in a radial direction of the inner U-phase coil 5Ui is arranged on the inner side in the radial direction of an end on the inner side in the radial direction of the outer V-phase coil 5Vo. In a circumferential direction, a position of the inner U-phase coil 5Ui and a position of the outer V-phase coil 5Vo are shifted for a size of one tooth 10.

Each of second coil sets 32 is formed of an inner V-phase coil 5Vi, and an outer W-phase coil 5Wo arranged in such a manner as to overlap with a part of the inner V-phase coil 5Vi. An end on the inner side in the radial direction of the inner V-phase coil 5Vi is arranged on the inner side in the radial direction of an end on the inner side in the radial direction of the outer W-phase coil 5Wo. In the circumferential direction, a position of the inner V-phase coil 5Vi and a position of the outer W-phase coil 5Wo are shifted for the size of the one tooth 10.

Each of third coil sets 33 is formed of an inner W-phase coil 5Wi, and an outer U-phase coil 5Uo arranged in such a manner as to overlap with a part of the inner W-phase coil 5Wi. An end on the inner side in the radial direction of the inner W-phase coil 5Wi is arranged on the inner side in the radial direction of an end on the inner side in the radial direction of the outer U-phase coil 5Uo. In the circumferential direction, a position of the inner W-phase coil 5Wi and a position of the outer U-phase coil 5Uo are shifted for the size of the one tooth 10.

In the embodiment, the first coil sets 31, the second coil sets 32, and the third coil sets 33 are arranged in such a manner as not to overlap with each other.

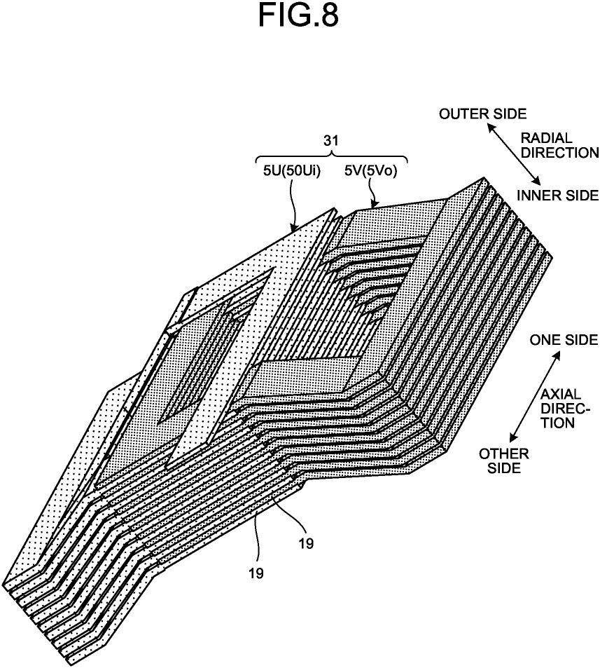

FIG. 8 is a perspective view illustrating the first coil set 31 according to the embodiment. In the embodiment, the coils 5 are formed of plate-shaped segment conductors 19. The coils 5 are formed by connection of the plurality of segment conductors 19 in a spiral shape.

In the first coil set 31, the segment conductors 19 of the inner U-phase coil 5Ui and a part of the segment conductors 19 of the outer V-phase coil 5Vo are alternately arranged in the radial direction.

Similarly, in the second coil set 32, the segment conductors 19 of the inner V-phase coil 5Vi and a part of the segment conductors of the outer W-phase coil 5Wo are alternately arranged in the radial direction. In the third coil set 33, the segment conductors 19 of the inner W-phase coil 5Wi and a part of the segment conductors 19 of the outer U-phase coil 5Uo are alternately arranged in the radial direction.

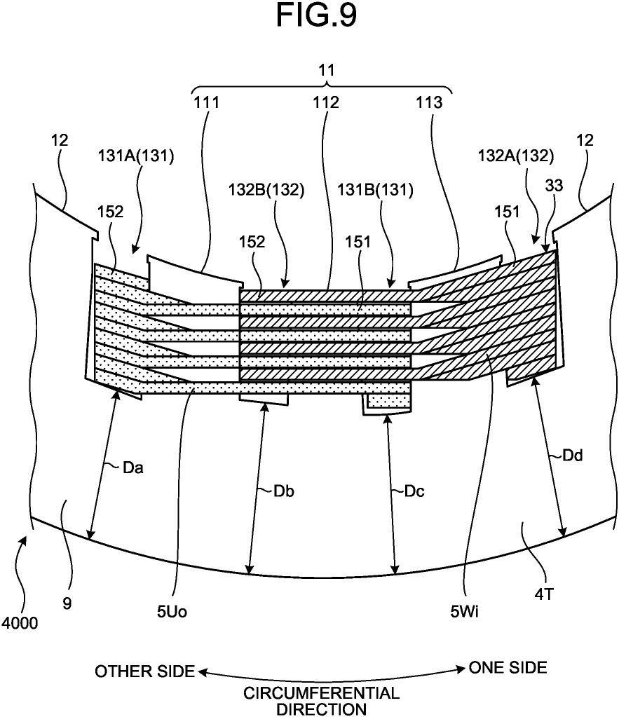

FIG. 9 is a view illustrating the third coil set 33 arranged in slots 13 according to the embodiment. As illustrated in FIG. 9, three mounted teeth 11 are arranged in such a manner as to be adjacent to each other in the circumferential direction. The three mounted teeth 11 include first, second, and third mounted teeth 111, 112, and 113 arranged in such a manner as to be adjacent to each other in the circumferential direction. The third mounted tooth 113 is arranged next to one side in the circumferential direction of the second mounted tooth 112. The second mounted tooth 112 is arranged next to one side in the circumferential direction of the first mounted tooth 111.

One non-mounted tooth 12 is arranged in such a manner as to be adjacent to the mounted tooth 11 in the circumferential direction. The non-mounted tooth 12 is arranged in such a manner as to be adjacent to the first mounted tooth 111 or the third mounted tooth 113 in the circumferential direction. One first mounted tooth 111, one second mounted tooth 112, one third mounted tooth 113, and one non-mounted tooth 12 are arranged side by side in the circumferential direction.

The third coil set 33 is mounted on the three mounted teeth 11 adjacent to each other in the circumferential direction. In the third coil set 33, the outer U-phase coil 5Uo is mounted on the first mounted tooth 111 and the second mounted tooth 112, and the inner W-phase coil 5Wi is mounted on the second mounted tooth 112 and the third mounted tooth 113. The segment conductors 19 of the outer U-phase coil 5Uo and the segment conductors 19 of the inner W-phase coil 5Wi are alternately arranged in the radial direction in a part of a periphery of the second mounted tooth 112.

The slots 13 include first slots 131 in which the outer U-phase coil 5Uo is arranged, and second slots 132 in which the inner W-phase coil 5Wi is arranged.

The first slots 131 include a first non-overlapping slot 131A in which a second coil main body 152 of the outer U-phase coil 5Uo is arranged, and a first overlapping slot 131B in which a first coil main body 151 of the outer U-phase coil 5Uo is arranged.

The second slots 132 include a second non-overlapping slot 132A in which a first coil main body 151 of the inner W-phase coil 5Wi is arranged, and a second overlapping slot 132B in which a second coil main body 152 of the inner W-phase coil 5Wi is arranged.

The first non-overlapping slot 131A is provided between the first mounted tooth 111 and a non-mounted tooth 12 next to the other side in the circumferential direction of the first mounted tooth 111. The first overlapping slot 131B is provided between the second mounted tooth 112 and the third mounted tooth 113.

The second non-overlapping slot 132A is provided between the third mounted tooth 113 and a non-mounted tooth 12 next to the one side in the circumferential direction of the third mounted tooth 113. The second overlapping slot 132B is provided between the second mounted tooth 112 and the first mounted tooth 111.

A depth of the first non-overlapping slot 131A, a depth of the first overlapping slot 131B, a depth of the second non-overlapping slot 132A, and a depth of the second overlapping slot 132B are different.

In the embodiment, the first non-overlapping slot 131A is the deepest, the first overlapping slot 131B is the second deepest next to the first non-overlapping slot 131A, the second non-overlapping slot 132A is the third deepest next to the first overlapping slot 131B, and the second overlapping slot 132B is the shallowest.

As illustrated in FIG. 9, a yoke thickness Da in the first non-overlapping slot 131A, a yoke thickness Db in the second overlapping slot 132B, a yoke thickness Dc in the first overlapping slot 131B, and a yoke thickness Dd in the second non-overlapping slot 132A are different. In the embodiment, the yoke thickness Db is the largest, the yoke thickness Dd is the second largest next to the yoke thickness Db, the yoke thickness Dc is the third largest next to the yoke thickness Dd, and the yoke thickness Da is the smallest.

The first slot 131 in which the outer U-phase coil 5Uo of the third coil set 33 is arranged, and the second slot 132 in which the inner W-phase coil 5Wi of the third coil set 33 is arranged have been described above with reference to FIG. 9. As illustrated in FIG. 7, the plurality of first slots 131 is provided. The plurality of first slots 131 including the first non-overlapping slot 131A and the first overlapping slot 131B are provided at different positions in the circumferential direction. The plurality of second slots 132 including the second non-overlapping slots 132A and the second overlapping slots 132B is provided. The plurality of second slots 132 is provided at different positions in the circumferential direction. Similarly to the third coil set 33, the outer V-phase coil 5Vo of the first coil set 31 is arranged in the first slots 131, and the inner U-phase coil 5Ui of the first coil set 31 is arranged in the second slots 132. The outer W-phase coil 5Wo of the second coil set 32 is arranged in the first slots 131, and the inner V-phase coil 5Vi of the second coil set 32 is arranged in the second slots 132.

### Effect

As described above, the depth of the first non-overlapping slot 131A, the depth of the first overlapping slot 131B, the depth of the second non-overlapping slot 132A, and the depth of the second overlapping slot 132B are different. Thus, the yoke thickness Db in the second overlapping slot 132B and the yoke thickness Dd in the second non-overlapping slot 132A are larger than the yoke thickness Dc in the first overlapping slot 131B and the yoke thickness Da in the first non-overlapping slot 131A. Since the yoke thickness Db in the second overlapping slot 132B and the yoke thickness Dd in the second non-overlapping slot 132A are large, an increase in magnetic flux density between an outer end surface 13B of the second overlapping slot 132B and the outer surface 4T is controlled, and an increase in magnetic flux density between an outer end surface 13B of the second non-overlapping slot 132A and the outer surface 4T is controlled. Thus, a loss generated in the stator core 4000 is reduced.

The number of the coils 5 arranged in an overlapped manner in the radial direction is two. As a result, a size of the stator 2000 in the radial direction is controlled. Thus, an increase in a size of the motor 1 is controlled.

A combination of the phase of the inner coil 5i and the phase of the outer coil 5o varies among the first coil sets 31, the second coil sets 32, and the third coil sets 33. As a result, a rotating magnetic field is appropriately generated in the stator 2000.

### [Other Embodiments]

In the above-described embodiments, it is assumed that the motor 1 is an inner rotor type in which the rotor 3 is arranged inside the stator core 4. The rotor 3 only needs to be arranged at a position facing the stator core 4. The motor 1 may be an outer rotor type in which a rotor 3 is arranged outside a stator core 4, a dual rotor type in which a rotor 3 is arranged on each of an inner side and outer side of a stator core 4, or an axial gap type in which a rotor 3 is arranged on a side of an axial direction of a stator core 4.

In the above-described embodiments, it is assumed that the motor 1 is a switched reluctance motor. The motor 1 may be a synchronous reluctance motor, a flux switching motor, a permanent magnet motor, an induction motor, an axial gap motor, or a linear actuator.

In the above-described embodiments, it is assumed that the motor 1 is a three-phase motor. The motor 1 may be a four-phase motor.

Reference Signs List

| | |
|---|---|
| 1 | MOTOR |
| 2 | STATOR |
| 3 | ROTOR |
| 4 | STATOR CORE |
| 4A | END SURFACE |
| 4B | END SURFACE |
| 4S | INNER SURFACE |
| 4T | OUTER SURFACE |
| 5 | COIL |
| 5 o | OUTER COIL |
| 5 i | INNER COIL |
| 5U | U-PHASE COIL |
| 5V | V-PHASE COIL |
| 5W | W-PHASE COIL |
| 5Ui | INNER U-PHASE COIL |
| 5Vi | INNER V-PHASE COIL |
| 5Wi | INNER W-PHASE COIL |
| 5Uo | OUTER U-PHASE COIL |
| 5Vo | OUTER V-PHASE COIL |
| 5Wo | OUTER W-PHASE COIL |
| 6 | ROTOR HOLDER |
| 7 | ROTOR CORE |
| 8 | ROTOR SHAFT |
| 9 | YOKE |
| 10 | TOOTH |
| 11 | MOUNTED TOOTH |
| 12 | NON-MOUNTED TOOTH |
| 13 | SLOT |
| 13A | OPENING |
| 13B | OUTER END SURFACE |
| 15 | COIL MAIN BODY |
| 16 | COIL END PORTION |
| 19 | SEGMENT CONDUCTOR |
| 30 | COIL SET |
| 31 | FIRST COIL SET |
| 32 | SECOND COIL SET |
| 33 | THIRD COIL SET |
| 111 | FIRST MOUNTED TOOTH |
| 112 | SECOND MOUNTED TOOTH |
| 113 | THIRD MOUNTED TOOTH |
| 131 | FIRST SLOT |
| 131A | FIRST NON-OVERLAPPING SLOT |
| 131B | FIRST OVERLAPPING SLOT |
| 132 | SECOND SLOT |
| 132A | SECOND NON-OVERLAPPING SLOT |
| 132B | SECOND OVERLAPPING SLOT |
| 151 | FIRST COIL MAIN BODY |
| 152 | SECOND COIL MAIN BODY |
| 161 | FIRST COIL END PORTION |
| 162 | SECOND COIL END PORTION |
| 200 | STATOR |
| 400 | STATOR CORE |
| 2000 | STATOR |
| 4000 | STATOR CORE |
| AX | ROTATION AXIS |
| D1 | YOKE THICKNESS |
| D2 | YOKE THICKNESS |
| Da | YOKE THICKNESS |
| Db | YOKE THICKNESS |
| Dc | YOKE THICKNESS |
| Dd | YOKE THICKNESS |
| RS | OBJECT |

1. A stator comprising:
a stator core having a plurality of teeth arranged in a circumferential direction and slots each of which is provided between the teeth adjacent to each other; and
coils mounted on the plurality of teeth, wherein
the coils include outer coils arranged at a first distance from a center of the stator core and inner coils arranged at a second distance from the center of the stator core, the second distance being shorter than the first distance,
the slots include first slots in which the outer coils are arranged and second slots in which the inner coils are arranged,
a depth of the first slots is deeper than a depth of the second slots,
each of coil sets is formed of each of the inner coils and the outer coil arranged in such a manner as to overlap with a part of the inner coil,
a phase of the inner coil and a phase of the outer coil are different in each of the coil sets,
the coil sets include a first coil set, a second coil set, and a third coil set, and
a combination of the phase of the inner coil and the phase of the outer coil varies among the first coil set, the second coil set, and the third coil set.

2. The stator according to claim 1, wherein
the outer coils include an outer U-phase coil, an outer V-phase coil, and an outer W-phase coil,
the inner coils include an inner U-phase coil, an inner V-phase coil, and an inner W-phase coil,
the first coil set is formed of the inner U-phase coil and the outer V-phase coil arranged in such a manner as to overlap with a part of the inner U-phase coil,
the second coil set is formed of the inner V-phase coil and the outer W-phase coil arranged in such a manner as to overlap with a part of the inner V-phase coil, and
the third coil set is formed of the inner W-phase coil and the outer U-phase coil arranged in such a manner as to overlap with a part of the inner W-phase coil.

3. The stator according to claim 2, wherein
the first coil set, the second coil set, and the third coil set are arranged in such a manner as not to overlap with each other.

4. The stator according to claim 2, wherein
the first slots and the second slots are alternately arranged one by one in the circumferential direction.

5. The stator according to claim 2, wherein
the inner U-phase coil of the first coil set and a part of the outer W-phase coil of the second coil set are arranged in such a manner as to overlap with each other,
the inner V-phase coil of the second coil set and a part of the outer U-phase coil of the third coil set are arranged in such a manner as to overlap with each other, and
the inner W-phase coil of the third coil set and a part of the outer V-phase coil of the first coil set are arranged in such a manner as to overlap with each other.

6. The stator according to claim 5, wherein
the first slots and the second slots are alternately arranged two by two in the circumferential direction.

7. The stator according to claim 3, wherein
a conductor of the inner coil and a part of a conductor of the outer coil are alternately arranged in a radial direction in each of the coil sets.

8. The stator according to claim 7, wherein
first, second, and third mounted teeth to which the coil sets are mounted are arranged in such a manner as to be adjacent to each other in the circumferential direction, and a non-mounted tooth on which the coil sets are not mounted is arranged in such a manner as to be adjacent to the first mounted tooth or the third mounted tooth in the circumferential direction,
the outer coils are mounted on the first and second mounted teeth,
the inner coils are mounted on the second and third mounted teeth,
the first slots include a first non-overlapping slot between the first mounted tooth and the non-mounted tooth, and a first overlapping slot between the second mounted tooth and the third mounted tooth,
the second slots include a second non-overlapping slot between the third mounted tooth and the non-mounted tooth, and a second overlapping slot between the second mounted tooth and the first mounted tooth, and
a depth of the first non-overlapping slot, a depth of the first overlapping slot, a depth of the second non-overlapping slot, and a depth of the second overlapping slot are different.

9. A motor comprising:
the stator according to claim 1; and
a rotor that faces the stator core.
